(19) United States
(12) Patent Application Publication
(10) Pub. No.: US 2025/0111226 A1
(43) Pub. Date: Apr. 3, 2025

(54) MODEL TRAINING METHODS AND APPARATUS

(71) Applicant: BEIJING VOLCANO ENGINE TECHNOLOGY CO., LTD., Haidian District, Beijing (CN)

(72) Inventors: Han QIAN, Beijing (CN); Dongyan ZHOU, Beijing (CN); Rui SHI, Beijing (CN)

(21) Appl. No.: 18/833,235

(22) PCT Filed: May 22, 2023
(86) PCT No.: PCT/CN2023/095464

§ 371 Date: Jul. 25, 2024

(30) Foreign Application Priority Data
Jun. 16, 2022 (CN) 202210689425.2

(51) Int. Cl. G06N 3/08; G06F 9/28; G06F 9/38

(52) U.S. Cl. CPC G06N 3/08; G06F 9/28; G06F 9/3867

(57) ABSTRACT

The present disclosure relates to a model training method and apparatus. The method includes: invoking a task segmentation thread to segment task data to obtain a plurality of consecutive slice data, and sequentially caching the slice data in a slice data queue; invoking a task distribution thread to read a slice data to be processed from the slice data queue and generating a task to be processed based on the slice data to be processed; and determining a target model trainer based on a task execution progress of each model trainer involved in model training, distributing the task to be processed to the target model trainer and instructing the target model trainer to execute the task to be processed.

### CROSS-REFERENCE TO RELATED APPLICATIONS

The present disclosure is based on and claims priority of Chinese application for invention number 202210689425.2, filed on Jun. 16, 2022, the disclosure of which is hereby incorporated into this disclosure by reference in its entirety.

### TECHNICAL FIELD

This disclosure relates to the technical field of data processing, in particular to a model training method and apparatus.

### BACKGROUND

In machine learning, as the amount of training data becomes larger and larger, current machine learning adopts a data parallel approach to speed up training. The current mainstream training framework supports data parallel by dividing a large dataset equally according to the number of computing nodes. This approach requires a lot of time for data slicing prior to training, and for some businesses that use a large amount of tidal data, the corresponding compute nodes need to be constantly online or offline, resulting in a constantly changing degree of parallelism in training, which affects the overall efficiency of model training.

### SUMMARY

In a first aspect, the present disclosure provides a model training method, comprising: invoking a task segmentation thread to segment task data to obtain a plurality of consecutive slice data, and sequentially caching the slice data in a slice data queue which is configured to dynamically maintain processing situations of the slice data; invoking a task distribution thread to read a slice data to be processed from the slice data queue and generating a task to be processed based on the slice data to be processed; and determining a target model trainer based on a task execution progress of each model trainer involved in model training, distributing the task to be processed to the target model trainer and instructing the target model trainer to execute the task to be processed, wherein the task segmentation thread and the task distribution thread run in parallel.

In a second aspect, the present disclosure provides a model training apparatus, comprising: a task segmentation module configured to invoke a task segmentation thread to segment task data to obtain a plurality of consecutive slice data, and sequentially cache the slice data in a slice data queue which is configured to dynamically maintain processing situation of the slice data; and a task distribution module configured to invoke a task distribution thread to read a slice data to be processed from the slice data queue and generate a task to be processed based on the slice data to be processed, determine a target model trainer based on a task execution progress of each model trainer involved in model training, distribute the task to be processed to the target model trainer and instruct the target model trainer to execute the task to be processed, wherein the task segmentation thread and the task distribution thread run in parallel.

In a third aspect, the present disclosure provides an electronic device, comprising: a memory and a processor, the memory configured to store computer program instructions; and the processor configured to execute the computer program instructions to cause the electronic device to implement the model training method according to the first aspect or any embodiments of the first aspect.

In a fourth aspect, the present disclosure provides a readable storage medium, comprising: computer program instructions that, when executed by an electronic device, cause the electronic device to implement the model training method according to the first aspect or any embodiments of the first aspect.

In a fifth aspect, the present disclosure provides a computer program product that, when executed by at least one processor of an electronic device, cause the electronic device to implement the model training method according to the first aspect or any embodiments of the first aspect.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the disclose or the technical solutions in the related technologies, a brief introduction will be given below for the drawings required to be used in the description of the embodiments or the related technologies. It is obvious that, for a person skilled in the art, he or she may also acquire other drawings according to such drawings on the premise that no inventive effort is involved.

FIG. 1 is a diagram showing an overall framework of a model training apparatus provided in embodiments of the present disclosure;

FIG. 2 is a flowchart of a model training method provided in some embodiments of the present disclosure;

FIG. 3 is a flowchart of a model training method provided in other embodiments of the present disclosure;

FIG. 4 is a flowchart of a model training method provided in still other embodiments of the present disclosure;

FIG. 5 is a structure diagram of a model training apparatus provided in some embodiments of the present disclosure; and

FIG. 6 is a schematic structural diagram of an electronic device provided in some embodiments of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

At present, the main process of parallel model training is to, first, segment a task dataset, and then distribute the slice data obtained by segmentation evenly to each training node. Each training node then invokes a corresponding model trainer to train with the received slice data. For example, if a task dataset is segmented to obtain 16 slice data, assuming there are 4 training nodes, the 16 slice data are able to evenly distributed across 4 training nodes. Training node 1 computes on slice data 1, 5, 9, 13, training node 2 computes on slice data 2, 6, 10, 14, training node 3 computes on slice data 3, 7, 11, 15, and training node 4 computes on slice data 4, 8, 12, 16.

This present model training method has at least the following shortcomings.

1. For a large task dataset, a significant amount of time needs to be spent on data slicing before training. Due to the limitations of existing model training frameworks, data slicing and training are not able to be carried out simultaneously, resulting in lower overall model training efficiency.

2. At present, model training is generally solved via several data stages. It is up to the user to handle checkpoints in the model training process. A checkpoint is an internal event that, in response to being activated, exports data in a memory (comprising various parameters of the model). In the model training scenario, a checkpoint is triggered after a data training stage has been completed.

In the model training scenario, checkpoint processing is synchronous and model training is not able to be performed during checkpoint processing, resulting in idle compute resources in the training nodes and severe resource waste. In addition, each data stage requires repeated task slicing and scheduling of model training resources, which wastes a lot of scheduling time and leads to low model training efficiency. In addition, if a task to be processed fails, it is only recovered using the parameters stored at the previous checkpoint, which means that data has to be recalculated between checkpoints, thereby wasting a lot of computing power.

3. The data is always dynamically updated. For example, new task data can be collected during model training. To train with the newly added task data, it is necessary to segment and distribute the new task data and import the previously trained model parameters. The newly added task data will result in a longer training time.

4. The number of training nodes is dynamically updated. For example, the online or offline deployment of some functions or training nodes lead to dynamic changes in the data to be processed, and the parallelism of model training is also constantly changing, which affect the overall efficiency of model training.

5. The environment is heterogeneous and complex. The term “environmental heterogeneity” comprises heterogeneity in machine hardware, software, networks, and workload on different training nodes. This results in significant differences in the training speed of different training nodes, and the training speed of these training nodes is not able to be predicted in advance, leading to a serious imbalance in training speed. If fixed slices are used, there will be serious long tail problems which will affect the overall efficiency of the training. The long-tail problem arises from the fact that in a parallel training scenario, the execution time of the entire model training is determined based on the completion time of the last training node. If a training node has a slow training speed, the method of evenly distributing slice data will lead to a longer training time of the entire model, thereby affecting the overall efficiency of model training.

Based on the above issues, this disclosure provides a model training method and apparatus which decouples the task scanning, segmenting and distributing processes and is executed in parallel by a task scanning thread, a task segmentation thread and a task distribution thread. Therefore, this pipeline processing method does not have the defect that data slicing must be performed prior to task distribution and execution, which greatly reduces the data preparation time prior to task execution and improves the efficiency of model training.

In addition, the model training method provided in this disclosure adopts a centralized approach, in which task execution status is stored in a unified and uninterrupted manner, which is able to timely restore the status of a task to be processed in case of an emergency and solve the shortcomings of multi-stage execution data processing.

In addition, the model training method provided in this disclosure is able to detect newly added task data in a timely manner through dynamic scanning. The newly added task data is cached in a task data queue, and the task segmentation thread obtains one or more slice data by segmenting the newly added task data. The slice data are cached in the task data queue and the task distribution thread retrieves the newly added task data from the task data queue to generate and distribute corresponding tasks to be processed. Since the task segmentation thread and the task distribution thread run in parallel, they do not affect the execution of the tasks to be processed by the training nodes, thereby solving the problem of dynamically adding task data that not to be processed in a timely manner.

In addition, the model training method provided in this disclosure is able to dynamically distribute and recycle tasks based on changes in the number of training nodes, thereby effectively controlling the parallelism of the tasks to be processed. In addition, dynamic task distribution is better adapted to the problem of heterogeneous nodes by distributing more tasks to be processed to training nodes with faster processing speed and fewer tasks to be processed to training nodes with slower processing speed, ensuring that the resources of each training node are fully utilized and improving the overall model training efficiency.

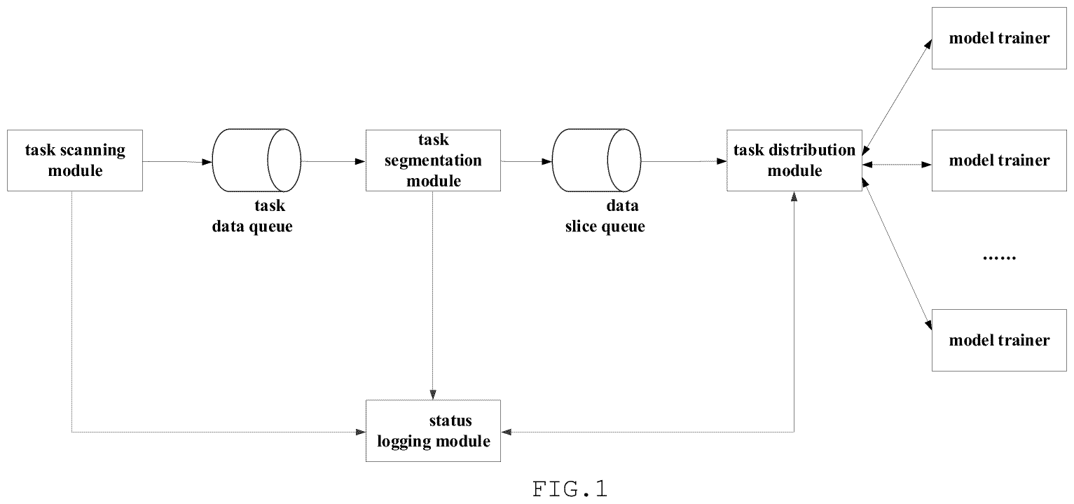

FIG. 1 is a diagram showing an overall framework of a model training apparatus provided in some embodiments of the present disclosure. Referring to FIG. 1, the framework mainly comprises: a task scanning module, a task segmentation module, a task distribution module, and multiple model trainers.

The task scanning module is primarily configured to invoke a task scanning thread to scan task data, and sorts the task data which is scanned according to a user-specified sorting strategy before storing it in a task data queue. The task data queue is set up on a disk. At the start of model training, a preset size of storage space on the disk is allocated to the task data queue, which is configured to cache the task data sequentially scanned by the task scanning thread.

The task segmentation module is primarily configured to read the task data from the task data queue by invoking a task segmentation thread, and perform data slicing to obtain a plurality of consecutive slice data, and then sequentially cache the plurality of consecutive slice data obtained to the slice data queue. The method of data slicing is not limited, and is evenly sliced or sliced according to a preset strategy.

The task distribution module is primarily configured to read the slice data to be processed from the slice data queue by invoking a task distribution thread, generate corresponding task to be processed, and dynamically distribute the task to be processed based on the task execution situation of downstream model trainers.

The model trainers are mainly responsible for executing the task to be processed distributed by the task distribution thread. An appropriate task pool is maintained for a model trainer. The size of the task pool can be fixed. For example, the task pool can contain 4, 5 or 6 tasks to be processed. This disclosure does not limit the size of the task pool, which is set according to practical needs. The model trainer is able to read the task to be processed from the task pool and train the sliced data after parsing.

In this disclosure, the task scanning thread, the task segmentation thread and the task distribution thread are executed in parallel. Pipelined processing does not have the disadvantage of sequential execution of data scanning, data slicing and data distribution and training. Therefore, the method of this disclosure is able to reduce the time consumption of model training and improve the efficiency of model training.

In some embodiments, the model training apparatus can also comprise a status logging module. The status logging module is able to record the state of each thread and the task execution status of each task distributed to each model trainer.

For example, each model trainer reports state of the current task pool to the task distribution thread according to a pre-defined strategy (e.g. regular reporting or reporting at a specific time), to make the task distribution thread is able to reasonably distribute task to be processed based on the task execution situation of each model trainer. For example, in response to a task in a model trainer being finished (i.e. training ends) and the number of tasks to be processed left in the current task pool being 2 less than 4 (the number of tasks to be processed in the task pool size is 4), the task distribution thread will take 2 slice data to be processed from the slice data queue to generate 2 tasks to be processed and distribute them to the model trainer, thereby ensuring that there is a sufficient number of tasks to be processed in the task pool of the model trainer.

In addition, during the process of model training, reading a task to be processed from the task pool, the model trainer is able to send the task execution status of the currently executing task to be processed to the task distribution thread, in order to record the task execution status corresponding to the executing task in the memory through the task distribution thread. By recording the task execution status of the task to be processed, it is possible to recover a failed task caused by an offline model trainer based on the task execution status. The task execution status comprises, but is not limited to: an offset corresponding to the slice data of the task to be processed, which can be configured to determine which part of the slice data has been used in training and which part has not, thereby determining training progress.

In addition, the task scanning thread, the task segmentation thread and the task distribution thread are also able to send their respective states, such as scanned paths, sliced paths and distributed tasks to be processed, to the status logging module for storage.

As a possible implementation, the status logging module is implemented in the following way.

1. The status logging module is implemented suing the HDFS system (Distributed File System). Due to the potentially high cost of status logging, adopting the HDFS system is able to reduce external dependencies and hardware costs.

2. Status logging in a centralized manner. for a large number of tasks to be processed, creating a task execution status file for each task to be processed is able to lead to a large number of files with a small amount of information stored in the files, resulting in a serious “small file” problem. However, the method provided in this disclosure adopts a centralized status logging method, in which the training node continuously reports the task execution status of each task, and the task distribution thread uniformly collects the task execution status corresponding to the task of each training node and stores the task execution status (such as an offset corresponding to a slice data), thereby solving the “small file” problem.

3. In this disclosure, the training node stores the task execution status of each task that needs to be read and written in real time in the memory, and periodically and asynchronously synchronizes the task execution status of each task stored in the memory to the HDFS system by the task distribution thread.

4. Due to the possibility of a large number of tasks to be processed, in response to the execution status of each task to be processed being stored entirely in the memory of the task distribution thread, the demand for memory is high. In order to reduce the hardware requirements for memory, different information is recorded for different types of tasks in this disclosure. For example, for successfully completed tasks, task identification information is recorded; for failed tasks, task identification information of the failed tasks and identification information of training nodes that failed to execute the task are recorded; for tasks being executed, all the execution status of the tasks are recorded. In addition, different types of tasks are stored in different types of storage. For example, for successful and failed tasks, the task execution status is stored on the disk rather than in the memory; the execution status of tasks being executed is logged in the memory. Since the number of tasks being executed is equal to the product of the number of training nodes and the size of the task pool, it is a constant value and there is no risk of insufficient memory.

5. In the model training method provided in this disclosure, the status logging module is also able to record the scanning progress information of the task scanning thread (the scanning progress information comprises paths of the scanned task data) and the slicing progress information of the task segmentation thread (the slicing progress information comprises paths of the sliced task data), which is able to prevent the problem of taking a long time to rescan and slice the task data during state recovery in response to the model training task abnormally terminating. This feature is particularly useful in response to all data processing being nearing completion. In such a scenario, the scanning and slicing time spent on task data will be much longer than the execution time of the task, resulting in a serious waste of computing resources. By recording the scanning progress information of the task scanning thread and the slicing progress information of the task segmentation thread, fast recovery is possible, effectively reducing the waste of computing resources.

In summary, the model training method provided in this disclosure is able to solve the above problems in current parallel training methods, thus greatly improving the efficiency of model training.

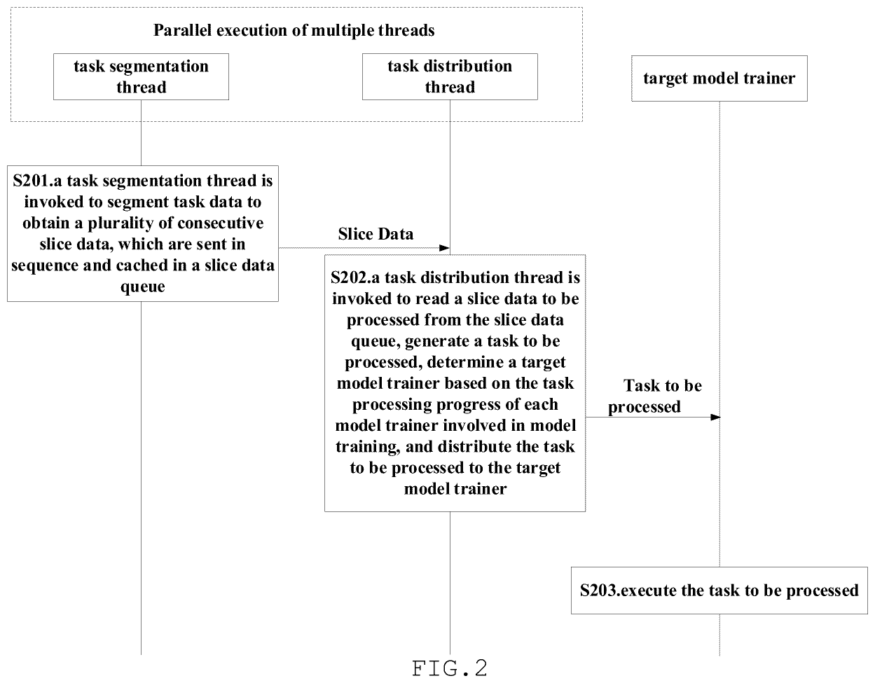

FIG. 2 is a flowchart of a model training method provided in some embodiments of the present disclosure. As shown in FIG. 2, the method of this embodiment comprises the following steps.

In S201, a task segmentation thread is invoked to segment task data to obtain a plurality of consecutive slice data, which are sent in sequence and cached in a slice data queue.

The task data is any type of data, such as image data, audio data, interaction data, test data, and so on. This disclosure does not have any limitations on the type of processing, data size, etc. of the task data.

The task data is sliced according to a fixed slice size or in other ways. For example, a plurality of different size levels are preset, and in response to the task data being read, it is sliced into a plurality of slices of different sizes based on the preset size levels, which is not specifically limited in this disclosure.

The slice data queue is configured to dynamically maintain processing situations of the slice data, and is set to the disk. The task segmentation thread caches the slice data obtained to a disk space corresponding to the slice data queue.

In S202, a task distribution thread is invoked to read a slice data to be processed from the slice data queue, generate a task to be processed, determine a target model trainer based on the task processing progress of each model trainer involved in model training, and distribute the task to be processed to the target model trainer, wherein the task segmentation thread and the task distribution thread run in parallel.

The slice data queue is set to the disk, and the plurality of slice data obtained by the task segmentation thread are stored on the disk. A small number of slice data are cached in the memory. In response to no slice data being in the memory, or the number of slice data being less than a preset amount, slice data are read in batch from the disk to the memory. The task distribution thread then reads slice data from the memory to generate task to be processed, thereby reducing memory usage.

In some embodiments, the task distribution thread is able to generate a task identifier (such as, a name, ID, etc.), and then encapsulate a slice data with the task identifier to generate a task to be processed.

As shown in FIG. 1, the model training device is able to obtain the task execution progress of each model trainer from the status logging module (i.e., the number of tasks in the task pool corresponding to the model trainer), and then determine whether new task to be processed is distributed to the model trainer based on the maximum number of tasks that are accommodated in the task pool of each model trainer. In response to the number of the tasks to be processed in the task pool being insufficient, new task to be processed is distributed to it, and the corresponding model trainer is able to become the target model trainer; in response to the number of the tasks to be processed in the task pool being sufficient, new task to be processed will not be distributed to it. In this disclosure, model trainers with task amounts less than the maximum number of the tasks that the corresponding model trainers are able to execute will be identified as candidate model trainers. The target model trainer is determined from the candidate model trainers, and the task to be processed is distributed to the target model trainer.

In response to determining the target model trainer from the candidate model trainers, it is determined based on one or more factors such as the number of slice data in the slice data queue and the number of candidate model trainers. For example, in response to the number of tasks that all candidate model trainers are able to receive being greater than the number of cached slice data in the slice data queue, some candidate model trainers are be selected as target model trainers; in response to the number of tasks that the candidate model trainers are able to receive being less than the number of slice data in the slice data queue, all the candidate model trainers are used as target model trainers, and tasks to be processed can be generated in the order of the slice data in the slice data queue and then distributed.

In addition, in response to the task distribution thread finding a newly added model trainer through scanning, and there is no task to be processed in the task pool corresponding to the newly added model trainer, a plurality of slice data are extracted from the slice data queue to generate a plurality of tasks to be processed to be distributed to the newly added model trainer.

In S203, the model trainer executes the distributed task to be processed.

The model trainer is able to read the task to be processed from the task pool and execute it for model training.

In this embodiment, the task segmentation thread and the task distribution thread run in parallel. During the distribution of tasks to be processed, the task segmentation thread is able to slice the read task data in parallel, eliminating the disadvantage of data slicing before task distribution, thereby reducing data preparation time and greatly improving model training efficiency.

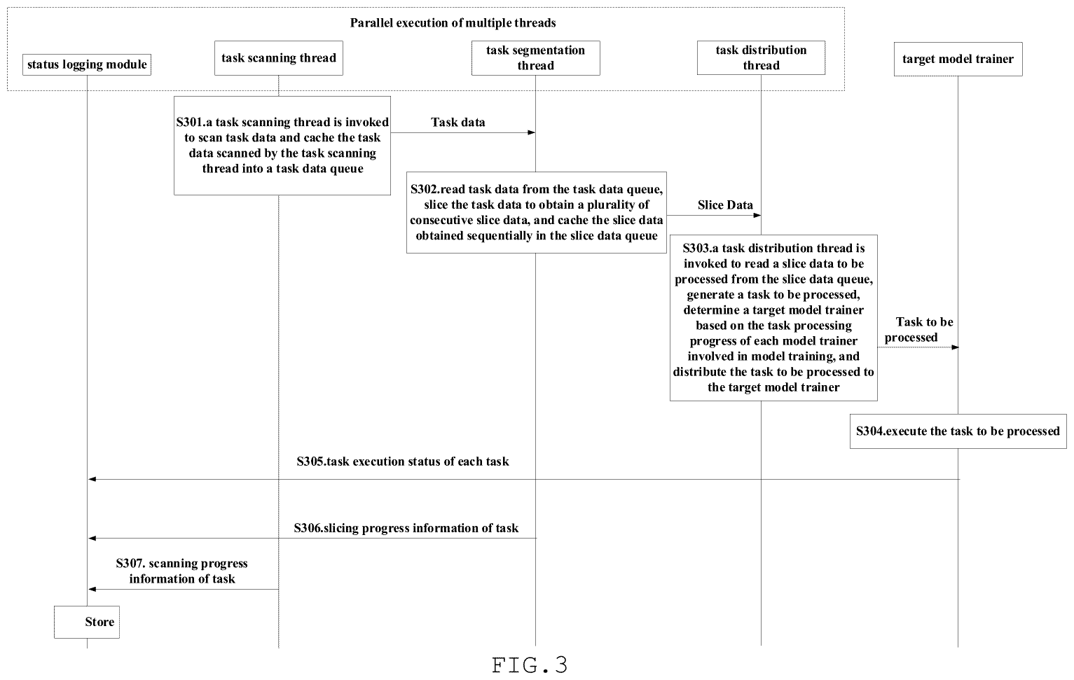

FIG. 3 is a flowchart of a model training method provided in other embodiments of the present disclosure. As shown in FIG. 3, the method of this embodiment comprises the following steps.

In S301, a task scanning thread is invoked to scan task data and cache the task data scanned by the task scanning thread into a task data queue.

The task data queue is configured to dynamically maintain the processing situation of the scanned task data. The task data queue is set to the disk, and the task data scanned by the task scanning thread is cached on the disk. A small amount of task data is cached in the memory. In response to no task data being in the memory or the amount of task data being less than a preset number, the task data is read from the disk to the memory in batch, thereby allowing the task segmentation thread to read the task data from the memory for data slicing, thereby reducing memory usage.

In S302, a task segmentation thread is invoked to read task data from the task data queue, slice the task data to obtain a plurality of consecutive slice data, and cache the slice data obtained sequentially in the slice data queue.

In S303, a task distribution thread is invoked to read a slice data to be processed from the slice data queue, generate a task to be processed, determine a target model trainer based on the task processing progress of each model trainer involved in model training, and distribute the task to be processed to the target model trainer, wherein the task scanning thread, the task segmentation thread, and the task distribution thread run in parallel.

In S304, the model trainer executes the task to be processed.

In this embodiment, steps S302 to S304 are similar to steps S201 to S203 in the embodiment shown in FIG. 2. Reference is made to the detailed description of the embodiment shown in FIG. 2, which will not be repeated for the sake of simplicity.

In S305, each model trainer sends task execution status to the task distribution thread, which records each task execution status in the memory and saves the status of completed tasks to the disk with preset triggers condition.

In this embodiment, each model trainer sends the task execution status of each task distributed to the model trainer, comprising a task identifier, a training progress (such as an offset of the slice data corresponding to the currently executing task), a model trainer ID, etc., to the task distribution thread, which records the task execution status in the memory. The task distribution thread then transfers the task status corresponding to the completed tasks (comprising successful and failed tasks) from the memory to the disk based on a preset trigger condition. After the transfer, the execution status of these tasks in the memory can be cleared. As a result, the execution status of all tasks is recorded, while reducing storage requirements for task state registration and hardware costs.

The preset trigger condition is periodic logging of task status or writing to the disk in response to a task being completed. Completed tasks comprise both successful and failed tasks. Therefore, the status in the memory is actually the status of tasks being executed.

In some embodiments, the method further comprises the following step.

In S306, the task segmentation thread is invoked to record slicing progress information of the task data in the memory, and periodically transfer the slicing progress information to the disk.

The slicing progress information is determined based on paths subjected to slicing. Therefore, as shown in FIG. 1, the task segmentation thread is able to send paths subjected to slicing to the status logging module (disk) for storage.

In some embodiments, the method further comprises the following step.

In S307, the task scanning thread is invoked to record scanning progress information of the data in the memory and periodically transfer the scanning progress information to the disk.

The scanning progress information is determined based on paths subjected to scanning. Therefore, as shown in FIG. 1, the task scanning thread is able to send paths subjected to scanning to the status logging module (disk) for storage.

By storing the status information of the task segmentation thread and the task scanning thread, it is possible to avoid the problem of spending a lot of time on re-scanning and re-slicing the task data during state recovery in response to the entire data processing process terminating abnormally.

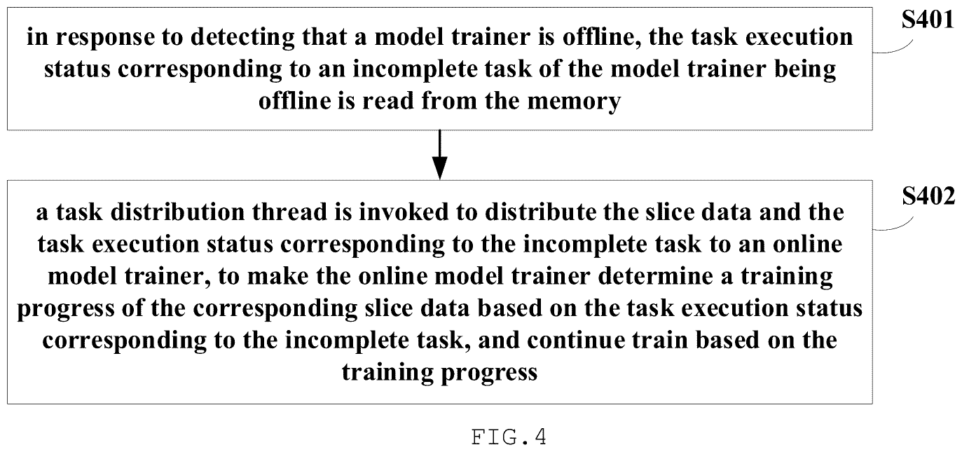

FIG. 4 is a flowchart of a model training method provided in still other embodiments of the present disclosure. As shown in FIG. 4, the method of this embodiment includes the following steps.

In S401, in response to detecting that a model trainer is offline, the task execution status corresponding to an incomplete task of the model trainer being offline is read from the memory.

The model trainer being offline is caused by user control, or abnormal downtime, etc. In response to a model trainer being controlled to be offline, the model trainer is able to perform a task execution status logging process in a case where of receiving an offline control instruction, to make the task distribution thread cache the latest task execution status in the memory; in response to the model trainer going offline due to abnormal downtime, the latest cached task execution status is read from the memory for task recovery. In this way, the training progress is determined more accurately, and the need for duplicate computations of slice data that have already been used in training is minimized.

Because the model trainer is offline, there may be incomplete tasks in the model trainer, which comprise tasks that have not been started and being executed in the task pool. These incomplete tasks need to be regathered and redistributed to ensure that they can be resumed.

In some embodiments, in response to resuming incomplete tasks in the offline model trainer, the task execution status corresponding to the incomplete tasks in the model trainer being offline is determined from the task execution status logged in the memory by matching based on the identifier of the model trainer being offline and the identifiers of the incomplete tasks.

The task execution status corresponding to the incomplete task comprises an offset of a corresponding slice data.

In S402, a task distribution thread is invoked to distribute the slice data and the task execution status corresponding to the incomplete task to an online model trainer, to make the online model trainer determine a training progress of the corresponding slice data based on the task execution status corresponding to the incomplete task, and continue train based on the training progress.

The invoked task distribution thread generates a new task to be processed based on the slice data and task execution status corresponding to the incomplete task, and distributes the new task to be processed to an online model trainer with an insufficient number of tasks in the task pool.

The model trainer receiving the task to be processed determines the training progress of the slice data based on the offset of the slice data contained in the task execution status. Then, by scanning the slice data to a position indicated by the corresponding offset, it continues to read the slice data for model training from that position without the need for recalculation based on the data already used for training, thereby reducing the computational workload of the model trainer and effectively improving the efficiency of model training.

In a specific example, assuming there are two tasks to be processed that have not yet been executed in the task pool of model trainer A, namely task 1 and task 2, and there are two running tasks, namely task 3 and task 4, the user instructs model trainer A to go offline. In response to model trainer A receiving an offline control instruction, a slice data corresponding to task 3 has been trained to the 100th line and a slice data corresponding to task 4 has been trained to the 120th line. Model trainer A sends the task execution progress of tasks 1 and 2 in the task pool and the offsets corresponding to tasks 3 and 4 to the task distribution thread, which stores them in the memory. Model trainer A then goes offline after completing other processes. Thereafter, the task distribution thread is able to obtain the task execution status corresponding to tasks 1 to 4 from the memory, and obtain slice data s corresponding to tasks 1 to 4. The slice data and task execution status corresponding to tasks 1 and 2 are distributed to model trainer B (equivalent to redistributing incomplete tasks 1 and 2 to model training B), and the slice data and task execution status corresponding to tasks 3 and 4 are distributed to model trainer C (equivalent to redistributing incomplete tasks 3 and 4 to model training C). Model trainer B is able to determine that tasks 1 and 2 have not been executed based on their task execution status, and then start scanning from the first row of the corresponding slice data for training. Based on the task execution status of tasks 3 and 4, model trainer C determines that the slice data contained in task 3 has been trained to the 100th row, and the slice data contained in task 4 has been trained to the 120th row. Therefore, model trainer C continues to read data from the 101st row of the corresponding slice data for task 3, and continues to read data from the 121st row of the corresponding slice data for task 4.

In the above example, recollection and redistribution of incomplete tasks in model trainer A are achieved. During redistribution, the training progress of each task is determined based on the corresponding task execution status of each incomplete task. This enables model trainers B and C receiving these incomplete tasks to accurately determine the training progress without having to train again with the first 100 rows of the slice data corresponding to task 3 or the first 120 rows of the slice data corresponding to task 4, thus reducing the computational load of the model trainers and improving the training efficiency.

By way of example, an embodiment of the present disclosure further provides a model training apparatus.

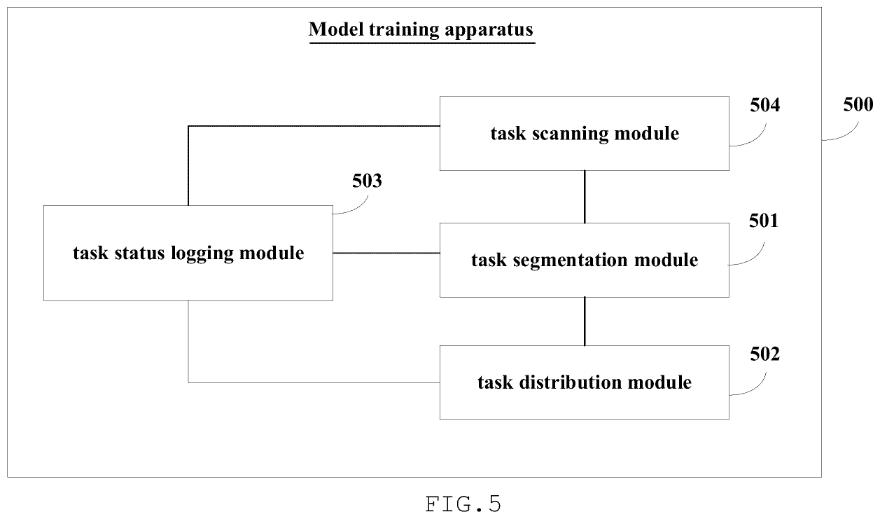

FIG. 5 is a structure diagram of a model training apparatus provided in some embodiments of the present disclosure. As shown in FIG. 5, the apparatus 500 provided in this embodiment comprises the following modules.
a task segmentation module 501 is configured to invoke a task segmentation thread to segment task data to obtain a plurality of consecutive slice data, and sequentially cache the slice data in a slice data queue that is configured to dynamically maintain processing situation of the slice data.
a task distribution module 502 is configured to invoke a task distribution thread to read a slice data to be processed from the slice data queue and generate a task to be processed based on the slice data to be processed, determine a target model trainer based on a task execution progress of each model trainer involved in model training, distribute the task to be processed to the target model trainer and instruct the target model trainer to execute the task to be processed, wherein the task segmentation thread and the task distribution thread run in parallel.

In some embodiments, the task distribution module 502 is specifically configured to scan and determine a number of tasks being executed in each model trainer, compare the number of tasks with a maximum number of tasks that a corresponding model trainer can execute, and determine a target model trainer from model trainers having a number of tasks less than the maximum number of tasks that the corresponding model trainer can execute.

In some embodiments, the task distribution module 502 is further configured to invoke a task distribution thread to obtain task execution status sent from each model trainer.

In some embodiments, the model training apparatus further comprises: a status logging module 503 configured to invoke the task distribution thread to record the task execution status in the memory, and save the task execution status of completed tasks to a disk with a preset trigger condition.

In some embodiments, the status logging module 503 is specifically configured to invoke the task distribution thread to record identification information of completed tasks to the disk, and record identification information and status information of tasks being executed in the memory.

In some embodiments, the status logging module 503 is further configured to invoke the task segmentation thread to record slicing progress information of the task data in the memory, and periodically transfer the slicing progress information to the disk.

In some embodiments, the apparatus further comprises: a data scanning module 504 configured to invoke a task scanning thread to scan task data and cache the scanned task data in a task data queue to make the task segmentation thread is able to obtain task data from the task data queue for slicing, wherein the task scanning thread and the task segmentation thread run in parallel.

In some embodiments, the status logging module 503 is further configured to invoke the task scanning thread to record data scanning progress information in the memory, and periodically transfer the scanning progress information to the disk.

In some embodiments, the task distribution module 502 is further configured to, in response to detecting that a model trainer is offline, read the task execution status corresponding to an incomplete task of the model trainer being offline from the memory; invoke the task distribution thread to distribute a slice data and the task execution status corresponding to the incomplete task to an online model trainer, to make the online model trainer determine a training progress of the corresponding slice data based on the task execution status corresponding to the incomplete task, and continue train based on the training progress.

The above modules can be implemented as software components running on one or more general-purpose processors, or as hardware performing specific functions or combinations thereof, such as programmable logic devices and/or specialized integrated circuits. In some embodiments, these modules can be embodied in the form of software products that can be stored in non-volatile storage media that enable computing devices (such as personal computers, servers, network devices, mobile terminals, etc.) to implement the methods described in the embodiments of the present disclosure. In other embodiments, the above modules may also be implemented on a single device or distributed across multiple devices. The functions of these modules can be combined or further divided into multiple sub-modules.

The model training apparatus provided in this embodiment can perform the model training method provided in any of the above method embodiments, and its principle of implementation and the technical effect achieved are similar to those of the method embodiments. Reference can be made to the above method embodiments for details, which will not be repeated for simplicity.

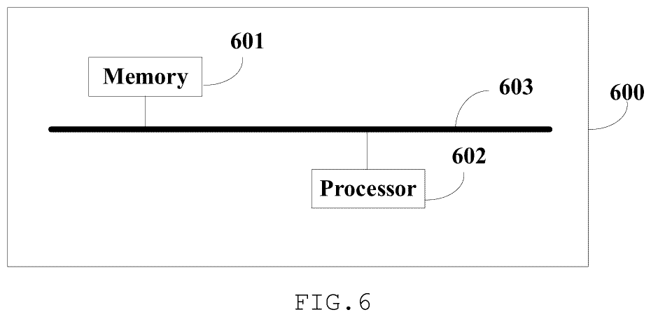

FIG. 6 is a schematic structural diagram of an electronic device provided in some embodiments of the present disclosure. As shown in FIG. 6, an electronic device 600 provided in this embodiment comprises: a memory 601 and a processor 602.

The memory 601 is an independent physical unit and is connected to the processor 602 by a bus 603. The memory 601 and the processor 602 is also integrated as hardware.

The memory 601 is configured to store program instructions, and the processor 602 invokes the program instructions to perform the operations of any one of the above method embodiments.

In some embodiments, in response to some or all of the methods of the above embodiments being implemented by software, the electronic device 600 may comprise only a processor 602. The memory 601 configured to store programs is located outside the electronic device 600, and the processor 602 is connected to the memory through circuits/wires for reading and executing programs stored in the memory.

The processor 602 can be a central processing unit (CPU), a network processor (NP), or a combination of CPU and NP.

The processor 602 may further comprise hardware chips. The above hardware chips may be application specific integrated circuits (ASICs), programmable logic devices (PLDs), or a combination thereof. The above PLD may be a complex programmable logic device (CPLD), a field programmable gate array (FPGA), a general array logic (GAL), or any combination of thereof.

The memory 601 may comprise volatile memory, such as random access memory (RAM). The memory may also comprise non-volatile memory, such as flash memory, hard disk drive (HDD), or solid-state drive (SSD). The memory may also comprise a combination of any of the above types of memory.

The present disclosure further provides a readable storage medium stored thereon computer program instructions that, when executed by a processor, implement the model training method according to any one of above method embodiments.

The present disclosure further provides a computer program product that, when running on a computer, causes the computer to implement the model training method according to any one of above method embodiments.

The present disclosure further provides a computer program, comprising: instructions that, when executed by a processor, cause the processor to implement the model training method according to any one of above method embodiments.

Note that, in this description, the use of relational terms, if any, such as “first” and “second” and the like are used solely to distinguish one from another entity or action without necessarily requiring or implying any actual such relationship or order between such entities or actions. Further, terms “include”, “comprise” or their any other variations are intended to encompass non-exclusive composition, so that a process, method, product or device comprising a series of factors may comprise not only these factors, but also other factors that are not listed explicitly, or factors intrinsic to this process, method, product or device. Without limitation, a factor defined by wording “comprise one . . . ” does not exclude the existence of other same factors in a process, method, product or device comprising such factor.

The above descriptions are only specific embodiments of the present disclosure, so that those skilled in the art can understand or implement the present disclosure. Various modifications to these embodiments will be apparent to those skilled in the art, and the generic principles defined herein may be implemented in other embodiments without departing from the spirit or scope of the present disclosure. Accordingly, the present disclosure should not be limited to the specific embodiments described herein, but should be accorded the broadest scope consistent with the principles and novel features disclosed herein.

What is claimed is:

1. A model training method, comprising:
invoking a task segmentation thread to segment task data to obtain a plurality of consecutive slice data, and sequentially caching the slice data in a slice data queue which is configured to dynamically maintain processing situations of the slice data;
invoking a task distribution thread to read a slice data to be processed from the slice data queue and generating a task to be processed based on the slice data to be processed; and
determining a target model trainer based on a task execution progress of each model trainer involved in model training, distributing the task to be processed to the target model trainer and instructing the target model trainer to execute the task to be processed, wherein the task segmentation thread and the task distribution thread run in parallel.

2. The model training method according to claim 1, wherein determining the target model trainer based on the task execution progress of each model trainer involved in model training comprises:
scanning a number of tasks being executed in each model trainer; and
comparing the number of tasks with a maximum number of tasks that a corresponding model trainer is able to execute, and determining the target model trainer from model trainers having a number of tasks less than the maximum number of tasks that the corresponding model trainer is able to execute.

3. The model training method according to claim 2, further comprising:
invoking the task distribution thread to obtain task execution status sent from each model trainer; and
invoking the task distribution thread to record the task execution status in a memory and save the task execution status of completed tasks to a disk with preset trigger condition.

4. The model training method according to claim 3, wherein invoking the task distribution thread to record the task execution status in a memory comprises:
invoking the task distribution thread to record identification information of the completed tasks to the disk and record identification information and status information of tasks being executed in the memory.

5. The model training method according to claim 1, further comprising:
invoking the task segmentation thread to record slicing progress information of the task data in a memory and periodically transfer the slicing progress information to a disk.

6. The model training method according to claim 1, further comprising:
invoking a task scanning thread to scan the task data and caching the task data which is scanned to a task data queue, to make the task segmentation thread obtain the task data from the task data queue for slicing, wherein the task scanning thread and the task segmentation thread run in parallel.

7. The model training method according to claim 6, further comprising:
invoking the task scanning thread to record scanning progress information of data in a memory and periodically transfer the scanning progress information to a disk.

8. The model training method according to claim 7, further comprising:
in response to detecting a model trainer is offline, obtaining task execution status corresponding to an incomplete task of the model trainer being offline from the memory; and
invoking the task distribution thread to distribute the slice data and the task execution status corresponding to the incomplete task to an online model trainer, to make the online model trainer determine a training progress of the slice data based on the task execution status corresponding to the incomplete task, and continue train based on the training progress.

9. (canceled)

10. An electronic device, comprising:
a memory configured to store computer program instructions; and
a processor configured to execute the computer program instructions to cause the electronic device to implement the model training method, comprising:
invoking a task segmentation thread to segment task data to obtain a plurality of consecutive slice data, and sequentially caching the slice data in a slice data queue which is configured to dynamically maintain processing situations of the slice data;
invoking a task distribution thread to read a slice data to be processed from the slice data queue and generating a task to be processed based on the slice data to be processed; and
determining a target model trainer based on a task execution progress of each model trainer involved in model training, distributing the task to be processed to the target model trainer and instructing the target model trainer to execute the task to be processed, wherein the task segmentation thread and the task distribution thread run in parallel.

11. A non-transitory readable storage medium stored thereon computer program instructions that, when executed by a processor, implement the model training method, comprising:
invoking a task segmentation thread to segment task data to obtain a plurality of consecutive slice data, and sequentially caching the slice data in a slice data queue which is configured to dynamically maintain processing situations of the slice data;
invoking a task distribution thread to read a slice data to be processed from the slice data queue and generating a task to be processed based on the slice data to be processed; and
determining a target model trainer based on a task execution progress of each model trainer involved in model training, distributing the task to be processed to the target model trainer and instructing the target model trainer to execute the task to be processed, wherein the task segmentation thread and the task distribution thread run in parallel.

12. (canceled)

13. The electronic device according to claim 10, wherein determining the target model trainer based on the task execution progress of each model trainer involved in model training comprises:
scanning a number of tasks being executed in each model trainer; and
comparing the number of tasks with a maximum number of tasks that a corresponding model trainer is able to execute, and determining the target model trainer from model trainers having a number of tasks less than the maximum number of tasks that the corresponding model trainer is able to execute.

14. The electronic device according to claim 13, wherein the processor configured to execute the computer program instructions to cause the electronic device to implement the model training method, further comprising:
invoking the task distribution thread to obtain task execution status sent from each model trainer; and
invoking the task distribution thread to record the task execution status in a memory and save the task execution status of completed tasks to a disk with preset trigger condition.

15. The electronic device according to claim 14, wherein invoking the task distribution thread to record the task execution status in memory comprises:
invoking the task distribution thread to record identification information of the completed tasks to the disk and record identification information and status information of tasks being executed in the memory.

16. The electronic device according to claim 10, wherein the processor configured to execute the computer program instructions to cause the electronic device to implement the model training method, further comprising:
invoking the task segmentation thread to record slicing progress information of the task data in a memory and periodically transfer the slicing progress information to a disk.

17. The electronic device according to claim 10, wherein the processor configured to execute the computer program instructions to cause the electronic device to implement the model training method, further comprising:
invoking a task scanning thread to scan the task data and caching the task data which is scanned to a task data queue, to make the task segmentation thread obtain the task data from the task data queue for slicing, wherein the task scanning thread and the task segmentation thread run in parallel.

18. The non-transitory computer-readable storage medium according to claim 11, determining the target model trainer based on the task execution progress of each model trainer involved in model training comprises:
scanning a number of tasks being executed in each model trainer; and
comparing the number of tasks with a maximum number of tasks that a corresponding model trainer is able to execute, and determining the target model trainer from model trainers having a number of tasks less than the maximum number of tasks that the corresponding model trainer is able to execute.

19. The non-transitory computer-readable storage medium according to claim 18, wherein the model training method further comprising:
invoking the task distribution thread to obtain task execution status sent from each model trainer; and
invoking the task distribution thread to record the task execution status in a memory and save the task execution status of completed tasks to a disk with preset trigger condition.

20. The non-transitory computer-readable storage medium according to claim 19, wherein invoking the task distribution thread to record the task execution status in memory comprises:
invoking the task distribution thread to record identification information of the completed tasks to the disk and record identification information and status information of tasks being executed in the memory.

21. The non-transitory computer-readable storage medium according to claim 11, wherein the model training method further comprising:
invoking the task segmentation thread to record slicing progress information of the task data in a memory and periodically transfer the slicing progress information to a disk.

22. The non-transitory computer-readable storage medium according to claim 11, wherein the model training method further comprising:
invoking a task scanning thread to scan the task data and caching the task data which is scanned to a task data queue, to make the task segmentation thread obtain the task data from the task data queue for slicing, wherein the task scanning thread and the task segmentation thread run in parallel.
